(19) United States
(12) Patent Application Publication
(10) Pub. No.: US 2024/0166025 A1
(43) Pub. Date: May 23, 2024

(54) SYSTEMS FOR ELECTRICALLY HEATING VEHICLE WINDSHIELD AND HVAC COMPONENTS

(71) Applicant: Denso International America, Inc., Southfield, MI (US)

(72) Inventors: James LINK, West Bloomfield, MI (US); Norihiko Enomoto, Southfield, MI (US); Kengo Sugimura, Southfield, MI (US); Yilin Tian, Farmington, MI (US); Robert Brinker, Ortonville, MI (US); Dwayne Taylor, Livonia, MI (US); Chris Paquette, Ferndale, MI (US); Michael Bima, Milford, MI (US)

(73) Assignee: Denso International America, Inc., Southfield, MI (US)

(21) Appl. No.: 18/512,865

(22) Filed: Nov. 17, 2023

Related U.S. Application Data
(60) Provisional application No. 63/426,532, filed on Nov. 18, 2022.
(60) Provisional application No. 63/426,549, filed on Nov. 18, 2022.

(51) Int. Cl. B60H 1/32; B60H 1/00; B60S 1/02

(52) U.S. Cl. CPC B60H 1/321; B60H 1/00278; B60S 1/026; H05B 3/86

(57) ABSTRACT

An electrical heating system for a vehicle. The system includes: a transparent metallic layer configured to be mounted to a transparent material, conduct electrical current, and increase in temperature to heat the transparent material in response to electrical current running across the transparent metallic layer; a power supply; a heating, ventilation, and air conditioning (HVAC) system configured to heat and cool a passenger cabin of the vehicle; and a control module. The control module is configured to: apply voltage from the power supply to the transparent metallic layer to heat the transparent material; and apply voltage from the power supply to a component of the HVAC system to heat the component of the HVAC system.

### CROSS-REFERENCE TO RELATED APPLICATIONS

This application claims the benefit of U.S. Provisional Application Nos. 63/426,532 and 63/426,549 (both filed on Nov. 18, 2022), the entire disclosures of which are incorporated herein by reference.

### FIELD

The present disclosure relates to systems for electrically heating vehicle glass surfaces, such as a windshield, and HVAC components.

### BACKGROUND

This section provides background information related to the present disclosure, which is not necessarily prior art.

Traditionally, vehicle windshields are defrosted, deiced, and/or defogged by directing a flow of hot air from vents of an HVAC system of the vehicle to the windshield to heat the glass. Ice or frost formed on the windshield is then melted by the heat from the glass of the windshield as it is heated by the hot airflow from the vents of the HVAC system. Similarly, any fog on the windshield dissipates as the glass is warmed to a temperature above the current dew point of the vehicle environment. Defrosting, deicing, and/or defogging the vehicle windshield using hot air from the HVAC system, however, can take a large amount of time and can consume a large amount of energy. For example, defrosting a vehicle windshield using hot air from the HVAC system can take 20 to 30 minutes and can consume 5.2 kilowatt-hours (kWh) of energy. As such, faster and more energy efficient methods and systems are needed.

### SUMMARY

This section provides a general summary of the disclosure, and is not a comprehensive disclosure of its full scope or all of its features.

The present disclosure provides for an electrical heating system for a vehicle. The system includes: a transparent metallic layer configured to be mounted to a transparent material, conduct electrical current, and increase in temperature to heat the transparent material in response to electrical current running across the transparent metallic layer; a power supply; a heating, ventilation, and air conditioning (HVAC) system configured to heat and cool a passenger cabin of the vehicle; and a control module. The control module is configured to: apply voltage from the power supply to the transparent metallic layer to heat the transparent material; and apply voltage from the power supply to a component of the HVAC system to heat the component of the HVAC system.

The present disclosure further provides for a heating system for a vehicle. The system includes the following: a power supply; a transparent metallic layer configured to be mounted to a transparent material; a heating, ventilation, and air conditioning (HVAC) system configured to heat and cool a passenger cabin of the vehicle, the HVAC system including a heat pump with an outside heat exchanger (OHX); and a control module. The control module is configured to: apply voltage from the power supply to the transparent metallic layer to heat the transparent material; and apply voltage from the power supply to the OHX to heat the OHX during an OHX defrost cycle. The OHX defrost cycle is initiated based on at least one of OHX refrigerant outlet temperature, OHX refrigerant outlet pressure, and OHX secondary coolant outlet temperature.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates an exemplary electrical heating system in accordance with the present disclosure for electrically heating a windshield or other glass surface of a vehicle;

FIG. 2 illustrates an exemplary vehicle including the electrical heating system of the present disclosure;

FIG. 3 illustrates layers of an exemplary windshield including a transparent metallic layer in accordance with the present disclosure;

FIG. 4 illustrates an exemplary HVAC system, the electrical heating system of the present disclosure configured to heat components of the HVAC system;

FIG. 5 illustrates an exemplary ventilation heat exchanger, the electrical heating system of the present disclosure configured to heat components of the ventilation heat exchanger;

FIG. 6 illustrates an exemplary method in accordance with the present disclosure for defrosting an outside heat exchanger of the HVAC system of FIG. 4;

FIG. 7 illustrates exemplary refrigerant state points of refrigerant in the HVAC system of FIG. 4;

FIG. 8 illustrates an additional HVAC system, the electrical heating system of the present disclosure configured to heat components of the HVAC system;

FIG. 9 illustrates another exemplary method in accordance with the present disclosure for defrosting an outside heat exchanger of the HVAC system of FIG. 8;

FIG. 10 illustrates exemplary refrigerant state points of refrigerant in the HVAC system of FIG. 8; and

FIG. 11 illustrates yet another HVAC system, the electrical heating system of the present disclosure configured to heat components of the HVAC system.

Corresponding reference numerals indicate corresponding parts throughout the several views of the drawings.

### DETAILED DESCRIPTION

Example embodiments will now be described more fully with reference to the accompanying drawings.

The present disclosure includes systems and methods for defrosting, deicing, and/or defogging a vehicle windshield and/or other glass surfaces (e.g., side windows, rear window, glass roof, etc.) by running electrical current through, or otherwise across, the windshield and/or other glass surfaces. Any suitable system for applying electrical current may be used, such as, but not limited to, a pulse-electro thermal deicing (PETD) heater system. The present disclosure applies to heating vehicle glass, as well as non-vehicular glass. The present disclosure is thus not limited to automotive applications. The present disclosure applies to any glass surfaces in need of defogging, deicing, defrosting, etc.

The present disclosure includes systems and methods configured to quickly and efficiently defrost, deice, and/or defog a vehicle windshield by heating the windshield through the application of a voltage to a transparent metallic layer of the windshield. The heat may be generated by a PETD heater system or any other suitable system configured to direct electrical current through or otherwise across a vehicle windshield and/or any other glass surfaces. Heat generated by the electrical current running through the transparent metallic layer of the windshield heats the windshield to defrost, deice, and/or defog the vehicle windshield. For example, the PETD heater system can quickly heat the windshield and melt a layer of ice formed on the windshield causing the remaining ice on the windshield to be separated from the windshield by a layer of water. Once the layer of water has formed between the windshield and the remaining ice on the windshield, the windshield wipers of the vehicle can be activated to brush the remaining ice off the windshield. In one embodiment, for example, defrosting a windshield using a PETD heater system in accordance with the present disclosure can take less than one minute and can consume 0.12 kWh of energy. Compared with the 20-30 minutes and 5.2 kWh required for a traditional system using hot air flow from an HVAC system, the PETD heater system can provide significant time and energy savings.

PETD heater systems and related concepts are shown and described in the following patents, which are incorporated herein by reference in their entirety: U.S. Pat. No. 6,870,139, titled “Systems and methods for modifying an ice-to-object interface”; U.S. Pat. No. 8,921,739, titled “Systems and methods for windshield deicing”; U.S. Pat. No. 10,473,381 “High-frequency self-defrosting evaporator coil”; U.S. Pat. No. 11,229,091, titled “Continuous resistance and proximity checking for high power deicing and defogging systems.”

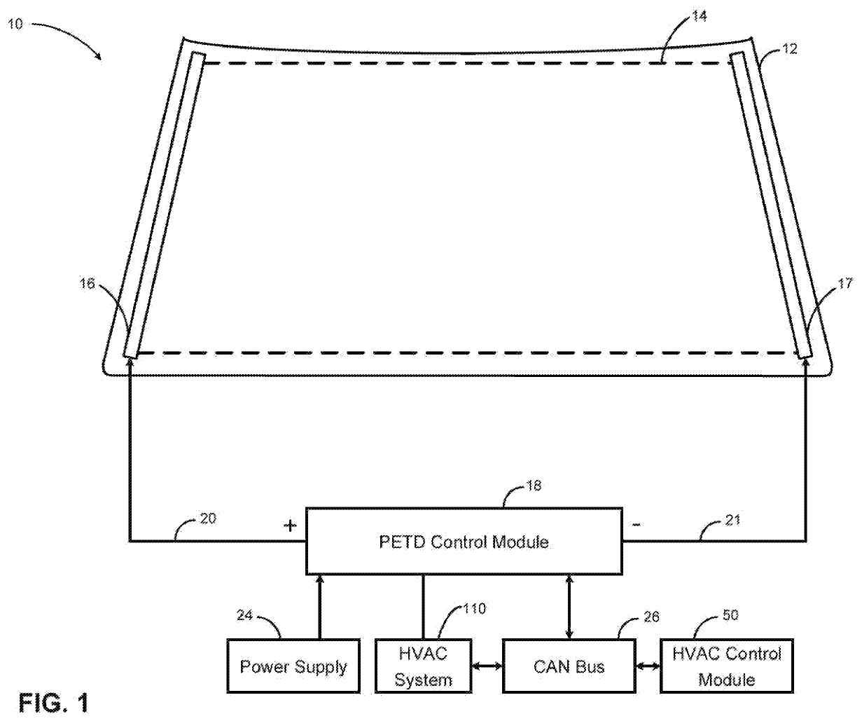

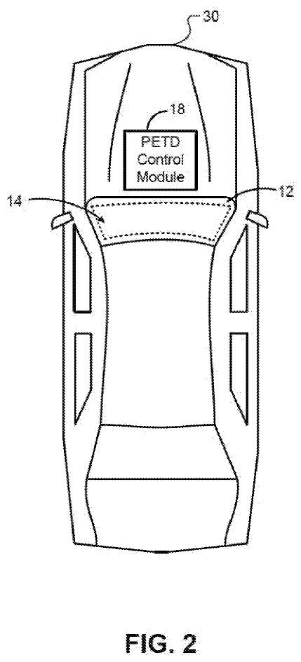

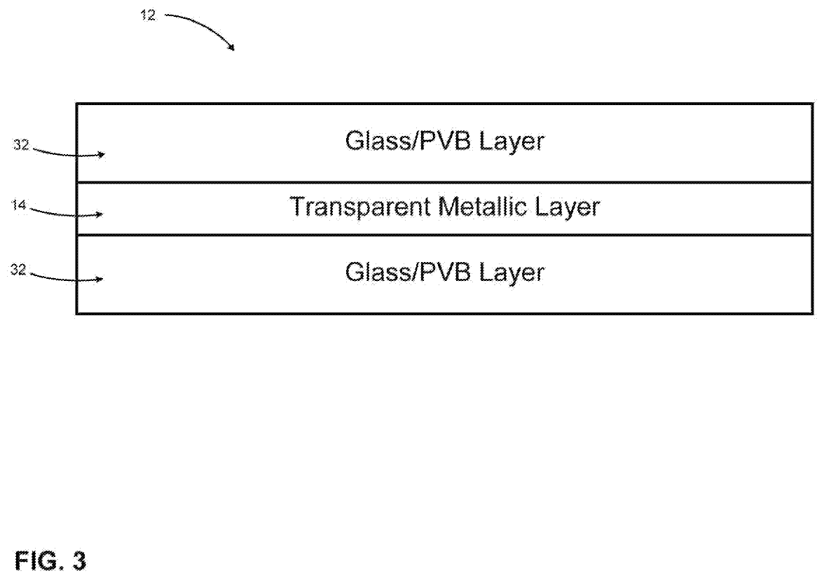

With reference to FIGS. 1-3, an exemplary PETD heater system 10 for a windshield 12 of a vehicle 30 is shown. The PETD heater system 10 includes a transparent metallic layer 14, also referred to as a transparent metallic sheet, embedded within the windshield 12. As shown in FIG. 3, the transparent metallic layer 14 can be sandwiched between one or more layers 32 of glass and/or polyvinyl butyral (PVB) shatter-resistant plastic. While the example of FIG. 3 includes a single transparent metallic layer 14 between layers 32 of glass or PVB, other configurations using additional transparent metallic layers 14 and/or additional glass or PVB layers can be used. The transparent metallic layer 14 in the windshield 12 can also be used to reflect infrared solar energy away from the interior of the vehicle 30.

The transparent metallic layer 14 is connected on opposite sides to bus bars 16, 17. While FIG. 1 shows the bus bars 16, 17 located on the left and right sides of the transparent metallic layer 14, the bus bars 16, 17 can alternatively be located on the top and bottom sides of the transparent metallic layer 14, or at other suitable locations. The bus bars 16, 17 are connected to a PETD control module 18 via wires 20, 21. The PETD control module 18 is connected to an electrical power supply 24 and a communication bus 26, such as a Controller Area Network (CAN) bus. The PETD control module 18 can, for example, be an electronic control unit (ECU) and can communicate with other ECUs and other devices or components of the vehicle 30 using the communication bus 26. The PETD control module 18 can be, and/or can include, a controller, a microcontroller, a microcomputer, or other computing device with a processor, memory, and/or other hardware and circuitry configured to control the PETD heater system 10 in accordance with the present disclosure.

The electrical power supply 24 can include one or more batteries of the vehicle 30. For example, in an electric vehicle the electrical power supply 24 can be a 400 to 900-volt battery. In a hybrid vehicle, the electrical power supply 24 can be a 36-volt battery. In an internal combustion engine vehicle, the electrical power supply 24 can be a 12-volt battery. While specific examples for batteries are provided, a battery of any suitable voltage can be used.

As shown in FIG. 1, wire 20 and bus bar 16 are shown as being on the positive terminal side and wire 21 and bus bar 17 are shown on the negative terminal side creating a voltage differential between the bus bars 16, 17 and allowing current to flow from the power supply 24 to the bus bars 16, 17 and across the transparent metallic layer 14. The control module 18 includes one or more switches, as necessary, to control and apply voltage to the wires 20, 21 and bus bars 16, 17. The voltage differential causes electrical current to flow across the transparent metallic layer 14, which heats the transparent metallic layer 14 and, in turn, heats the other layers of the windshield 12, such as the layers 32 of glass/PVB. The voltage applied to the bus bars 16, 17 and the transparent metallic layer 14 can be pulsed using a duty cycle or can be applied continuously until the PETD heater system 10 is turned off.

In this way, the PETD control module 18 controls the voltage applied to the bus bars 16, 17 and the flow of electrical current across the transparent metallic layer 14 to heat the windshield 12. As noted above, the heat from the windshield 12 can melt a thin layer of ice formed on the windshield 12 creating a thin layer of water between the windshield 12 and the remaining ice on the windshield 12. At that point, the windshield wipers of the vehicle 30 can be activated to brush the remaining ice off of the windshield 12. Similarly, the heat from the windshield 12 can also cause any fog or condensation formed on the windshield 12 to dissipate once the windshield 12 has been heated to above the current dew point of the environment of the vehicle 30.

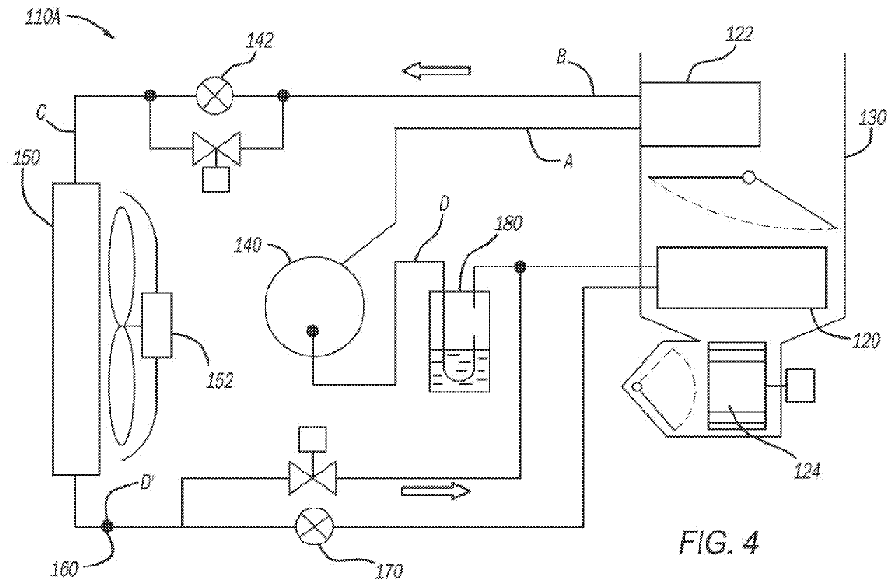

The PETD heater system 10 may also be configured to add heat to any suitable HVAC system to increase the overall efficiency and effectiveness of the HVAC system, such as when operated in a heating mode. For example, the PETD heater system 10 may be used to add heat to the HVAC system 110A of FIG. 4, which includes a heat pump. More specifically, the HVAC system 110A includes an evaporator 120 and a cabin condenser 122 downstream of a blower 124 within an HVAC case 130. A compressor 140 compresses refrigerant, which flows through the cabin condenser 122 to an expansion valve 142. From the expansion valve 142, refrigerant flows across an outside heat exchanger (OHX) 150. A cooling fan 152 generates airflow across the OHX 150. Downstream of the OHX 150 is a sensor 160, which is configured to sense temperature (T_{OHX}-T_{OUT}) and/or pressure (P_{OHX}-P_{OUT}) of refrigerant exiting the OHX 150. Between the OHX 150 and the evaporator 120 is an evaporative expansion valve 170. Upstream of the compressor 140 is an accumulator 180.

The HVAC system 110A is controlled by the HVAC control module 50, which is in communication with the PETD control module 18 by way of the CAN bus 26. The PETD control module 18 is configured to apply voltage to the HVAC system 110A by connecting the power supply 24 to any suitable components of the HVAC system 110 in any suitable manner, such as explained in the examples below.

The PETD control module 18 includes one or more switches, as necessary, to control and apply voltage from the power supply 24 to any suitable metallic component of the HVAC system 110 by way of any suitable electrical connection. In response to a command from the HVAC control module 50, the PETD control module 18 is configured to apply a voltage to the metallic component of the HVAC system 110A to heat the metallic component. Voltage may be applied to the HVAC system 110A, 110B, 110C in any suitable manner, such as pulsed voltage, constant voltage, etc.

For example, the PETD control module 18 may be wired to any metallic manifold or conduit of the HVAC system 110A carrying refrigerant or coolant therethrough. In response to a command from the HVAC control module 50, the PETD control module 18 is configured to apply a voltage to the manifold or conduit of the HVAC system 110A, which heats refrigerant or coolant flowing therethrough. Raising the temperature of the refrigerant or coolant increases the overall efficiency of the HVAC system 110 when in a heating mode. The manifold or conduit may include any suitable insulation layer, cover, etc. configured to retain heat and keep the heated refrigerant/coolant warm.

The PETD control module 18 may also be wired to metallic portions of the compressor 140, the cabin condenser 122, and/or a heater core of any suitable HVAC system, such as the HVAC system 110A. In response to a command from the HVAC control module 50, the PETD control module 18 is configured to apply a voltage to the compressor 140, cabin condenser 122, and/or the heater core of the HVAC system 110A. Applying a voltage to the compressor 140 heats the compressor, as well as the refrigerant therein to increase the temperature of the refrigerant and boost the efficiency of the HVAC system 110A when in a heating mode. Applying a voltage to the cabin condenser 122 (in a manner similar to a PTC heater) increases the temperature of the condenser coils, which are also heated by refrigerant flowing therethrough. Applying a voltage to the heater core (in a manner similar to a PTC heater) increases the temperature of the heater core coils, which are also heated by coolant flowing therethrough. Air blown across the condenser coils and heater core coils is thus heated not only by the refrigerant/coolant, but also by heat resulting from the voltage applied by the PETD control module 18, which gives a heat boost to the HAVC system 110 to increase the efficiency thereof. Voltage may be applied to the condenser 122 and heater core at the coils and/or tanks thereof.

The PETD control module 18 may be wired to a battery heat exchanger associated with any suitable battery, such as a battery configured to power a motor for driving an EV or HEV vehicle. The battery heat exchanger is configured to warm the battery when battery temperature is below an optimal operating temperature. In response to a command from the HVAC control module 50 (or a battery control module), the PETD control module 18 is configured to apply a voltage to any suitable metallic component of the battery heat exchanger. Applying voltage to the battery heat exchanger heats metallic components thereof, which then transfer heat to coolant of the battery heat exchanger, such as water. The heated coolant flows around and/or through the battery to warm the battery and raise the temperature of the battery to an optimal operating temperature.

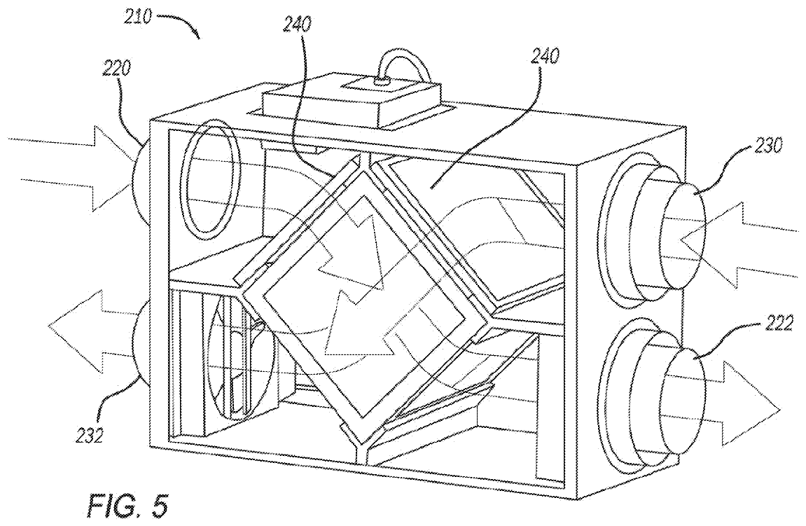

The PETD control module 18 may also be wired to a ventilation heat exchanger 210 of the vehicle 30 to de-ice the ventilation heat exchanger 210 or prevent icing. FIG. 5 illustrates an exemplary ventilation heat exchanger 210, which may be incorporated into the HVAC system 110 in any suitable manner. The ventilation heat exchanger 210 includes an inlet 220 for the introduction of fresh air from outside of the vehicle 30, an outlet 222 for delivering fresh air to inside of the vehicle 30, an inlet 230 for stale air from inside of the vehicle 30, and an outlet 232 for exhaust air to the outside of the vehicle 30. The airflow is filtered by filters 240 within the ventilation heat exchanger 210.

The PETD control module 18 may be wired to any metallic component of the ventilation heat exchanger 210 that is subject to icing. In response to a command from the HVAC control module 50, the PETD control module 18 is configured to apply a voltage to any suitable metallic component of the ventilation heat exchanger 210 that the PETD control module 18 is wired to. The voltage heats the metallic component of the ventilation heat exchanger 210 to de-ice, or prevent icing of, the ventilation heat exchanger 210. Any water vapor present may also be heated to evaporate the vapor and prevent icing.

The compressor 140 of the HVAC system 110A operates most efficiently when the refrigerant entering the compressor is entirely gas, or nearly 100% gas. Too much liquid refrigerant into the compressor may reduce the efficiency of the compressor or damage the compressor. Heating the suction line into the compressor will heat refrigerant flowing therethrough to vaporize the refrigerant, and make it less likely that liquid refrigerant will enter the compressor 140. If the suction line is metallic, the PETD control module 18 may be wired directly to the suction line to apply a current to the suction line when instructed by the HVAC control module 50. A non-metallic suction line may be wrapped in any suitable electrically conductive layer, such as a metallic layer similar to the metallic layer 14 of the PETD heater system 10. The metallic layer may also be embedded within the suction line. The suction line, and any metallic layer thereon or therein, may be wrapped in any suitable insulator so that the heat generated stays in the suction pipe to heat the refrigerant.

The PETD control module 18 may also be wired to the accumulator 180 of the HVAC system 110A to heat an accumulator bypass pipe. In response to a command from the HVAC control module 50, the PETD control module 18 is configured to apply a voltage to any suitable metallic component of the accumulator 180, such as an accumulator bypass pipe. Heating the bypass pipe will heat refrigerant therein to vaporize liquid refrigerant and avoid an unacceptable amount of liquid flowing to the compressor 140, which will advantageously eliminate a need for a shutoff valve. Also, adding heat to vaporize the liquid refrigerant will enhance heat exchange efficiency. If the accumulator bypass pipe is metallic, the current can be applied directly to the bypass pipe. Alternatively, the bypass pipe may be wrapped in, or include within, any suitable electrically conductive layer, such as a metallic layer similar to the metallic layer 14 of PETD heater system 10. The bypass pipe, and any suitable metallic layer thereon or therein, may be wrapped in any suitable insulator so that the heat generated stays in the bypass pipe to heat and vaporize liquid refrigerant.

The PETC control module 18 and/or the power supply 24 may be configured in any suitable manner to supply current to the HVAC system 110A at any suitable voltage. For example, voltage of the power supply 24 may be stepped down from a 400-900V EV battery to 60V or less, such as 48V or less. Voltage of the power supply 24 may be stepped up from 12V or 36V to 48V or 60V, for example.

The PETD control module 18 may be wired to any suitable metallic portion of an outside heat exchanger (OHX) 150 of the HVAC system 110A. In response to a command from the HVAC control module 50, the PETD control module 18 is configured to apply a voltage to any suitable metallic portion of the OHX 150. For example, the voltage may be applied to a center of the OHX 150, such as at a center of the coils. Heating the coils and/or tanks of the OHX 150 melts any ice that has formed thereon and helps prevent freezing and icing of the OHX 150 in cold conditions, and will also evaporate water on the surface of the OHX 150 to prevent re-freezing. Voltage may be applied to the tanks of the OHX as well. The OHX 150 may be connected to ground at any suitable location, such as on an outside surface.

It is desirable to avoid frost accumulation on the OHX 150. The present disclosure includes detection of frost accumulation in automotive heat pump systems (either OHX fluid outlet temperature or pressure depending on system type) as a trigger for shutting down the heat pump system and engaging the PETD heater system 10 and other heat pump system components in a heat exchanger (OHX) defrost cycle. Downstream of the OHX 150 is the sensor 160, which is configured to measure temperature and/or pressure of refrigerant flowing from the OHX 150.

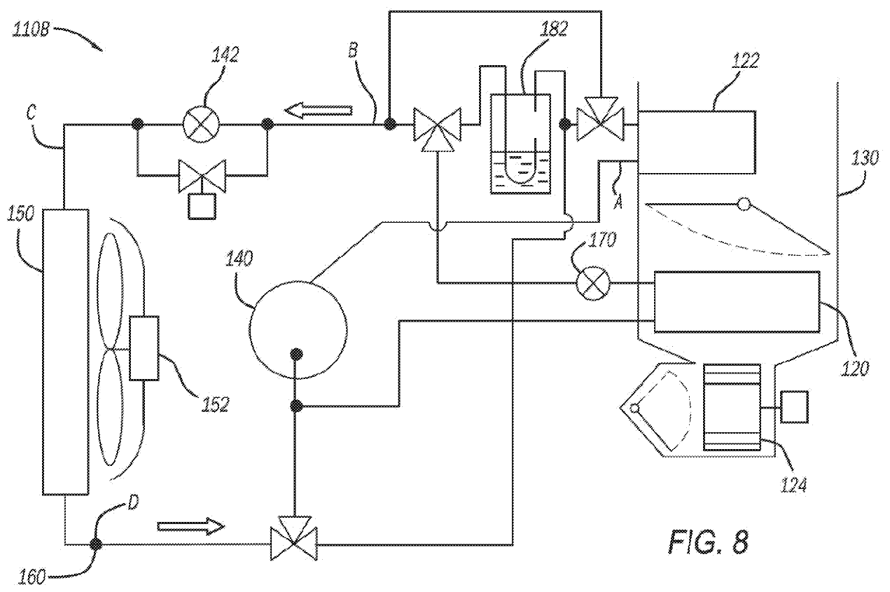

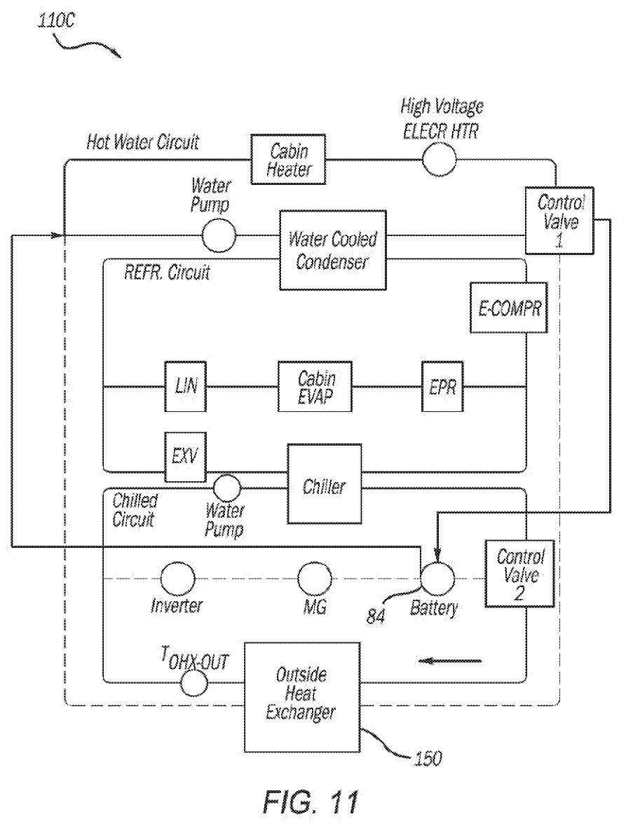

The present disclosure applies to any suitable heat pump system. For example, the present disclosure applies to at least the following: the HVAC system 110A of FIG. 4, which includes an accumulator cycle automotive heat pump system; the HVAC system 110B of FIG. 8, which includes a receiver cycle automotive heat pump system with a receiver 182; and the HVAC system 110C of FIG. 11, which includes a secondary fluid automotive heat pump system. The description of the HVAC system 110A set forth above also applies to the description the HVAC systems 110B and 110C unless specified otherwise.

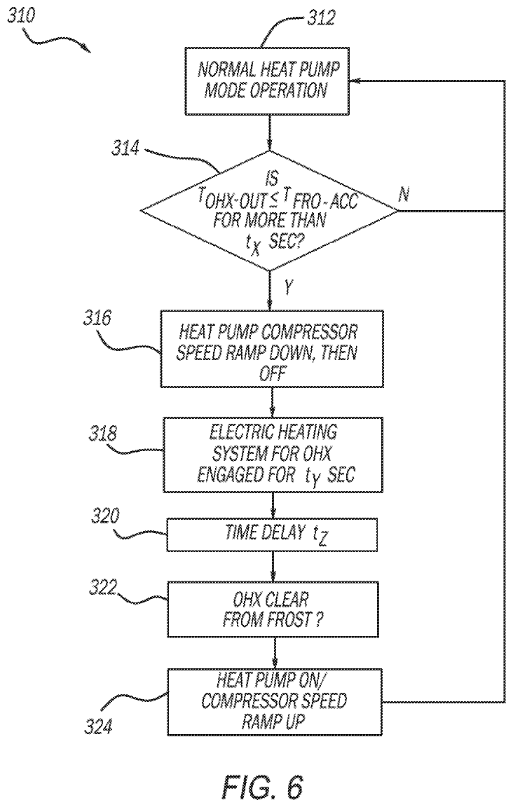

With respect to the accumulator cycle automotive heat pump system 110A of FIG. 4, during normal operation in heating mode, the system controller will modulate the OHX expansion valve 142 opening to control the amount of refrigerant flow into the OHX 150 in order to maintain target subcool at the outlet of the cabin condenser 122. When the OHX 150 has frost accumulation, heat transfer from ambient air to the refrigerant at the OHX 150 is blocked, and OHX refrigerant outlet temperature will rise as detected by the sensor 160. The present disclosure detects whether there is a need to engage the heater system 110 to heat the OHX based on OHX refrigerant outlet temperature at the sensor 160 in an accumulator cycle automotive heat pump system. An exemplary control sequence method 310 that the HVAC control module 50 is configured to perform is illustrated in FIG. 6.

At block 312 of the method 310, the HVAC system 110A is operating in normal heat mode operation. At block 314, the control module 18 determines whether the temperature of refrigerant exiting the OHX 150 (based on readings from the sensor 160) is equal to, or less than, a threshold refrigerant temperature corresponding to accumulation of frost on the OHX 150 (T_{FRO-ACC}). The control module 18 and/or the HVAC control module 50 is configured to identify this threshold temperature (T_{FRO-ACC}) based on various conditions, such as, but not limited to, the following: ambient temperature, vehicle operating conditions, and any other relevant factors as calculated by the control module 18 and/or the HVAC control module 50.

If at block 314, the temperature of refrigerant exiting the OHX 150 as measured by the sensor 160 is not equal to or less than the threshold refrigerant temperature corresponding to accumulation of frost on the OHX (T_{FRO-ACC}), then the method 310 returns to block 312. If at block 314 the temperature of refrigerant exiting the OHX 150 as measured by the sensor 160 is equal to or less than the threshold refrigerant temperature corresponding to accumulation of frost on the OHX 150 (T_{FRO-ACC}), then the method 310 proceeds to block 316.

At block 316, the HVAC control module 50 ramps down the speed of the compressor 140, and then shuts down the compressor 140. At block 318, the HVAC control module 50 and/or the control module 18 activate the heater system 10 to direct power from the power supply 24 to the OHX 150 to heat the OHX 150 for a predetermined period of time t_{y}. At block 320, after expiration of the time t_{y}, the HVAC control module 50 implements a predetermined time delay t_{z} prior to proceeding to block 322. After expiration of the time delay t_{z}, the method 310 proceeds to block 322. At block 322, a check is performed in any suitable manner to determine whether the OHX is clear of frost, or is likely to be clear of frost. Optionally at block 322, the HVAC control module 50 sets the OHX cooling fan speed to an increased, elevated speed of N_{H} for time tr to clear frost from the OHX 150. At block 324, the HVAC control module 50 activates the heat pump and ramps back up the speed of the compressor 140. From block 324, the method returns to 312.

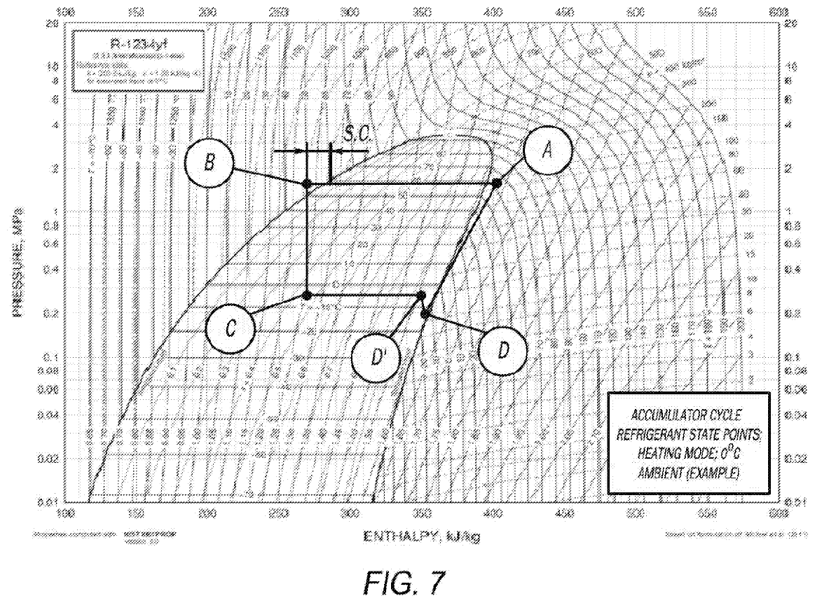

Increasing the OHX cooling fan to elevated speed N_{H} (which is the highest speed acceptable from NVH standpoint) immediately or after a very brief delay tz after the end of the electric heater system 10 engaged period to allow the surface of the OHX 150 to reach maximum temperature (temperature will continue to rise briefly after the heater system 10 is deactivated) facilitates frost removal. Doing so too early (or too late) can result in re-freezing of frost to the surface of the heat exchanger 150. Optimal values for t_{z} (as well as t_{Y}, t_{F} and N_{H} of FIG. 6) are predetermined in any suitable manner, such as by performing various trials. Although the flow chart of FIG. 6 illustrates sequential operation, the present disclosure contemplates an optimal condition where there may be some overlap between electric heating and elevated fan speed operation. The present disclosure includes both scenarios. FIG. 7 identifies refrigerant state points A, B, C, D, and D′, which correspond to the state of the refrigerant of the HVAC system 110A at locations A, B, C, D, and D′ respectively of FIG. 6.

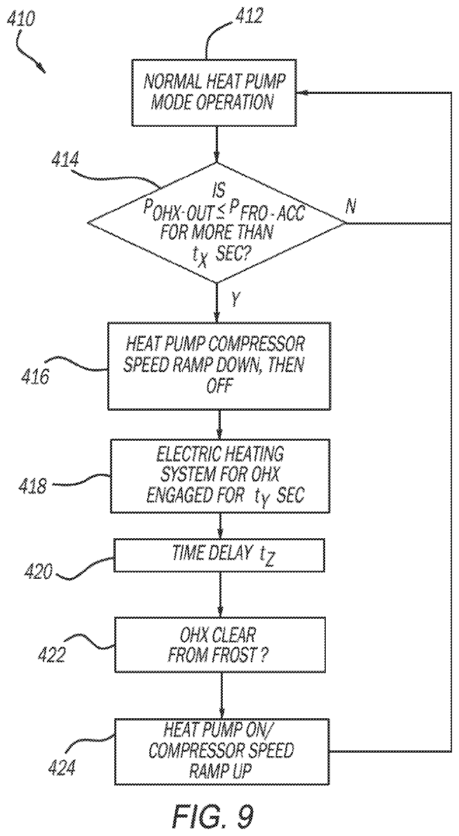

The HVAC system 110B and the receiver cycle automotive heat pump system of FIG. 8 will now be described in detail. An exemplary control sequence for the HVAC system 110B that the HVAC control module 50 is configured to perform is illustrated in FIG. 9 at method 410. The system 110B includes numerous components and features in common with the system 110A. With respect to such common features, the description of the features of the system 110A set forth above also applies to the system 110B. The method 410 is similar to the method 310, but the method 410 is directed to pressure of refrigerant at block 414 as compared to the method 310, which at block 314 is directed to temperature of refrigerant. The description of the method 310 also applies to the method 410 but for this difference, and to the extent described below.

Pressure of refrigerant downstream of the OHX 150 (P_{OHX-OUT}) will decrease as the OHX 150 gathers frost due to increased resistance of the frozen OHX 150 and its impact to refrigerant flow. Thus, frost accumulation on the OHX 150 lowers P_{OHX-OUT} (because the compressor is still on) and also lowers refrigerant temperature downstream T_{OHX-OUT} (see block 314) due to properties of the refrigerant.

At block 412 of the method 410, the HVAC control module 50 operates the HVAC system 110B in normal heat mode. During normal operation in heating mode of the receiver cycle automotive heat pump system (FIG. 8), the HVAC control module 50 modulates the opening of the OHX expansion valve 142 to control the amount of refrigerant flow into the OHX 150 in order to maintain target superheat at the OHX outlet as measured by the sensor 160. When frost accumulates on the OHX 150, heat transfer from ambient air to the refrigerant at the OHX is blocked, and OHX refrigerant outlet pressure will rise as detected by the sensor 160. The control method 410 of the present disclosure is configured to detect the need to engage the heater system 110 to heat the OHX 150 based on OHX refrigerant outlet pressure in a receiver cycle automotive heat pump system of the HVAC system 110B at block 414. Blocks 412-424 of the method 410 correspond to blocks 312-324 of the method 310, except at block 414 pressure is measured as compared to at block 314 where temperature is measured. But for this difference, the description of blocks 312-324 also applies to blocks 412-424.

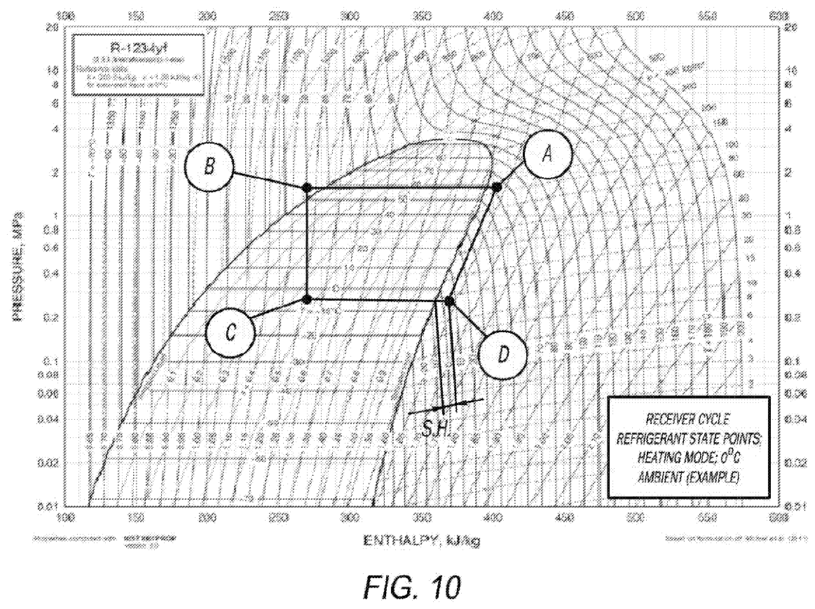

The threshold refrigerant pressure corresponding to accumulation of frost on the OHX 150 (P_{FRO-ACC}) is based on any suitable factors, such as, but not limited to, ambient temperature, vehicle operating conditions, etc., and is calculated by the HVAC control module 50. Increasing the speed of the OHX fan 152 to elevated speed N_{H} (highest speed acceptable from a noise, vibration, harness (NVH) standpoint) immediately or after a brief delay t_{z} after end of the PETD system engaged period to allow the outer surface of the OHX 150 to reach maximum temperature (temperature will continue to rise briefly after the electric heating system is 10 off) can aid in removal of frost. Doing so too early (or too late) can result in re-freezing of frost to the heat exchanger surface. Optimal values for t_{z} (as well as t_{Y}, t_{F} and N_{H}) may be established experimentally or in any other suitable manner. Though the flow chart of FIG. 9 shows the more likely case of sequential operation, the optimal condition may be to have some overlap between PETD operation and elevated fan speed operation. The present disclosure thus covers both scenarios. FIG. 10 identifies refrigerant state points A, B, C, and D, which correspond to the state of the refrigerant of the HVAC system 110C at locations A, B, C, and D respectively of FIG. 8.

FIG. 11 illustrates another HVAC system 110C including an outside heat exchanger 150, which is configured to be electrically heated with the heater system 110 of the present disclosure. The HVAC system 110C is configured to carry out the method 310 at FIG. 6. During normal operation in the heating mode in the secondary coolant automotive heat pump system of FIG. 11, the heat transfer between ambient to refrigerant is conducted via a secondary coolant loop. A typical secondary loop coolant is 50/50 water/ethylene glycol, though other suitable coolants can be used. The OHX 150 is still included, but contains the secondary coolant instead of refrigerant. The OHX 150 in such systems is still subject to frost accumulation since the secondary coolant must be chilled below ambient to absorb heat from ambient air.

When frost accumulates on the OHX 150 of the HVAC system 110C, heat transfer from ambient air to the refrigerant at the OHX 150 is blocked, and temperature of the OHX secondary coolant outlet temperature will rise. The method 310 provides for a control method including detecting a need to engage the heater system 10 to heat the OHX 150 based on OHX secondary coolant outlet temperature in a secondary coolant automotive heat pump system. “Frost accumulation indicated” OHX coolant outlet temperature T_{FRO-ACC} depends on ambient temperature, vehicle operating conditions, and other factors, and is calculated by the HVAC control module 50. Increasing the OHX cooling fan to elevated speed N_{H} (highest speed acceptable from a NVH standpoint) immediately or after a very brief delay T_{z} after end of the PETD system engaged period to allow the surface of the OHX 150 to reach maximum temperature (temperature will continue to rise briefly after heat is no longer applied to the OHX 150) can aid in removal of frost. Doing so too early (or too late) can result in re-freezing of frost to the heat exchanger surface. Optimal values for t_{z} (as well as t_{Y}, t_{F} and N_{H} shown in the flow chart) may be established experimentally in any suitable manner.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements.

As used herein, the phrase at least one of A, B, and C should be construed to mean a logical (A OR B OR C), using a non-exclusive logical OR. For example, the phrase at least one of A, B, and C should be construed to include any one of: (i) A alone; (ii) B alone; (iii) C alone; (iv) A and B together; (v) A and C together; (vi) B and C together; (vii) A, B, and C together. The phrase at least one of A, B, and C should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A. The term subset does not necessarily require a proper subset. In other words, a first subset of a first set may be coextensive with (equal to) the first set.

In this application, including the definitions below, the term “module” or the term “controller” may be replaced with the term “circuit.” The term “module” or the term “controller” may refer to, be part of, or include processor hardware (shared, dedicated, or group) that executes code and memory hardware (shared, dedicated, or group) that stores code executed by the processor hardware.

The module or controller may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module or controller may communicate with other modules or controllers using the interface circuit(s). Although the module or controller may be depicted in the present disclosure as logically communicating directly with other modules or controllers, in various implementations the module or controller may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module or controller may be distributed among multiple modules that are connected via the communications system. For example, multiple modules may implement the same functionality distributed by a load balancing system. In a further example, the functionality of the module or controller may be split between a server (also known as remote, or cloud) module and a client (or, user) module. For example, the client module may include a native or web application executing on a client device and in network communication with the server module.

The term code, as used above, may include software, firmware, and/or microcode, and may refer to programs, routines, functions, classes, data structures, and/or objects. Shared processor hardware encompasses a single microprocessor that executes some or all code from multiple modules or controllers. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective C, Swift, Haskell, Go, SQL, R, Lisp, Java®, Fortran, Perl, Pascal, Curl, Ocaml, JavaScript®, HTML5 (Hypertext Markup Language 5^{th} revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

What is claimed is:

1. An electrical heating system for a vehicle, comprising:
a transparent metallic layer configured to be mounted to a transparent material, conduct electrical current, and increase in temperature to heat the transparent material in response to electrical current running across the transparent metallic layer;
a power supply;
a heating, ventilation, and air conditioning (HVAC) system configured to heat and cool a passenger cabin of the vehicle; and
a control module configured to:
apply voltage from the power supply to the transparent metallic layer to heat the transparent material; and
apply voltage from the power supply to a component of the HVAC system to heat the component of the HVAC system.

2. The heating system of claim 1, wherein:
the transparent material includes glass;
the glass is one of a windshield, a side window, a rear window, and a roof; and
the control module is a pulse-electro thermal deicing (PETD) control module.

3. The heating system of claim 1, wherein:
the HVAC system includes a heat pump;
the component includes at least one of a manifold and a conduit of the heat pump configured to carry refrigerant; and
the control module is configured to apply voltage from the power supply to at least one of the manifold and the conduit to heat refrigerant flowing therethrough.

4. The heating system of claim 1, wherein:
the HVAC system includes a heat pump;
the component includes a compressor of the heat pump; and
the control module is configured to apply voltage from the power supply to the compressor to heat refrigerant flowing through the compressor.

5. The heating system of claim 1, wherein:
the HVAC system includes a heat pump;
the component includes a cabin condenser of the heat pump; and
the control module is configured to apply voltage from the power supply to the cabin condenser to heat air flowing across the cabin condenser.

6. The heating system of claim 1, wherein:
the HVAC system includes a heater core;
the component includes the heater core; and
the control module is configured to apply voltage from the power supply to the heater core to heat air flowing across the heater core.

7. The heating system of claim 1, wherein:
the HVAC system includes a heat pump;
the component includes an outside heat exchanger of the heat pump; and
the control module is configured to apply voltage from the power supply to the outside heat exchanger to de-ice the outside heat exchanger.

8. The heating system of claim 1, wherein:
the HVAC system includes a battery heat exchanger including coolant circulating about a battery;
the component includes the battery heat exchanger; and
the control module is configured to apply voltage from the power supply to the battery heat exchanger to heat the coolant.

9. The heating system of claim 1, wherein:
the HVAC system includes a ventilation heat exchanger including the component; and
the control module is configured to apply voltage from the power supply to the ventilation heat exchanger to heat the ventilation heat exchanger and prevent icing.

10. The heating system of claim 1, wherein:
the HVAC system includes a heat pump including a compressor;
the component includes at least one of a suction line of the compressor, and a conductive member seated on the suction line; and
the control module is configured to apply voltage from the power supply to at least one of the suction line and the conductive member seated on the suction line to heat refrigerant flowing through the suction line.

11. The heating system of claim 1, wherein:
the HVAC system includes a heat pump having an accumulator;
the component includes at least one of a bypass pipe of the accumulator and a conductive member seated on the bypass pipe; and
the control module is configured to apply voltage from the power supply to at least one of the bypass pipe and the conductive member seated on the bypass pipe to heat refrigerant flowing through the bypass pipe.

12. The heating system of claim 1, further comprising an insulation layer associated with the component configured to insulate the component from loss of heat generated by the heating system.

13. A heating system for a vehicle, the heating system comprising:
a power supply;
a transparent metallic layer configured to be mounted to a transparent material;
a heating, ventilation, and air conditioning (HVAC) system configured to heat and cool a passenger cabin of the vehicle, the HVAC system including a heat pump with an outside heat exchanger (OHX); and
a control module configured to:
apply voltage from the power supply to the transparent metallic layer to heat the transparent material; and
apply voltage from the power supply to the OHX to heat the OHX during an OHX defrost cycle;
wherein the OHX defrost cycle is initiated based on at least one of OHX refrigerant outlet temperature, OHX refrigerant outlet pressure, and OHX secondary coolant outlet temperature.

14. The heating system of claim 13, wherein the transparent material is configured as one of a windshield, a side window, a rear window, and a roof.

15. The heating system of claim 13, wherein the control module is configured to apply voltage to a metallic portion of the OHX including at least one of coils and tanks of the OHX.

16. The heating system of claim 13, further comprising a sensor configured to measure at least one of temperature and pressure of refrigerant flowing from the OHX;
wherein the control module is configured to apply voltage from the power supply to the OHX in response to a reading from the sensor indicating that at least one of the temperature and the pressure of the refrigerant flowing from the OHX is below a threshold indicative of frost accumulation on the OHX.

17. The heating system of claim 16, wherein:
prior to applying voltage from the power supply to the OHX, the control module is configured to ramp down and then stop a heat pump compressor of the HVAC system; and
subsequent to applying voltage to the OHX, the control module is configured to run an OHX cooling fan of the HVAC system at an increased speed to clear frost from the OHX, and resume operation of the heat pump compressor.

18. The heating system of claim 13, wherein the control module is further configured to apply voltage from the power supply to a secondary fluid automotive heat pump.

19. The heating system of claim 13, wherein the control module is further configured to apply voltage from the power supply to a metallic component of a heat pump to heat the metallic component.

20. The heating system of claim 13, wherein the control module is further configured to apply voltage from the power supply to a component of the HVAC system, the component including at least one of a heat pump manifold, a heat pump conduit configured to carry refrigerant, a compressor, a compressor suction line, a cabin condenser, a heater core, a battery heat exchanger, a ventilation heat exchanger, an insulation layer, and an accumulator.
